(19) United States
(12) Patent Application Publication
(10) Pub. No.: US 2018/0035813 A1
(43) Pub. Date: Feb. 8, 2018

(54) DEFORMATION DETECTION SENSOR AND PRODUCTION OF THE SAME

(71) Applicant: TOYO TIRE & RUBBER CO., LTD., Itami-shi, Hyogo (JP)

(72) Inventors: Takeshi Fukuda, Itami-shi, Hyogo (JP); Takuya Tsuzuki, Itami-shi, Hyogo (JP); Toshiaki Kawai, Itami-shi, Hyogo (JP)

(73) Assignee: TOYO TIRE & RUBBER CO., LTD., Itami-shi, Hyogo (JP)

(21) Appl. No.: 15/554,834

(22) PCT Filed: Mar. 2, 2016
(86) PCT No.: PCT/JP2016/056486

§ 371 Date: Aug. 31, 2017

(30) Foreign Application Priority Data
Apr. 9, 2015 (JP) 2015-080331
Apr. 9, 2015 (JP) 2015-080335

(51) Int. Cl. A47C 7/62; B60N 2/44; G01B 7/24; G01D 5/12; G01L 1/12; B60N 2/00; B60N 2/70; B60R 22/48; G01G 19/414; A47C 7/18; B29C 44/12

(52) U.S. Cl. CPC A47C 7/62; A47C 7/18; B60N 2/44; G01B 7/24; G01D 5/12; B29C 44/12; B60N 2/002; B60N 2/7017; B60R 22/48; G01G 19/4142; G01L 1/12; B60R 2022/4858

(57) ABSTRACT

The present invention provides a deformation detection sensor which combines a magnetic resin dispersing a magnetic filler in a resin with a magnetic sensor, of which stability of detection property is highly enhanced. The present invention thus provides a deformation detection sensor which comprises:
a magnetic resin-containing polymer foam which comprises a magnetic resin, in which a magnetic filler is contained, and a polymer foam in which the magnetic resin is included, and
a magnetic sensor that detects a magnetic change caused by a deformation of the magnetic resin-containing polymer foam,
wherein the magnetic resin has a convex portion on either a surface facing the magnetic sensor or a surface facing opposite to the magnetic sensor, and its production method.

### FIELD OF THE INVENTION

The present invention is related to a deformation detection sensor, in particular a deformation detection sensor used for a cushion pad for a car seat, and a production method thereof.

### BACKGROUND OF THE INVENTION

There has been practically used a warning system which detects whether a person is sit on a seat in a vehicle, such as an automobile and then alerts if the person does not couple a seat belt. The warning system generally gives off an alert when it detects the sitting of the person and simultaneously detects not coupling the seat belt. The apparatus generally comprises a sitting sensor which detects whether a person is sitting on a seat and a sensor which detects not coupling the seat belt with a buckle although the person is seated, which gives off an alert when the uncoupling of the seat belt is detected. The sitting sensor necessitates high durability because it must detect a person sitting down many times. It is also necessary that, when a person is seated, the person does not feel the sensation of any foreign object in the seat.

JP 2012-108113 A (Patent Document 1) discloses a sitting sensor equipped in a seat, detecting the sitting of a person, which comprises electrodes facing with each other in a cushion material and detects an electric contact of the electrodes. This sensor employs an electrode and should equip wiring. The wiring can be disconnected by receiving a large displacement and gives some problems in durability. In addition, the electrode is generally made of metallic substance which may create a sensation of a foreign object. Even if the electrode is not metallic, the feeling of a foreign object would easily generate based on the other substances.

JP 2011-255743 A (Patent Document 2) discloses an electrostatic capacitance-type sitting sensor which comprises sensor electrodes facing with each other, between which dielectric substance is inserted, and an electrostatic capacitance-type sensor that measures an electrostatic capacity between the electrodes. This sensor also employs electrodes and should equip wiring, which gives rise to durability problems as same with Patent Document 1. It is also difficult to prevent a sensation of a foreign object.

JP 2007-212196 A (Patent Document 3) discloses a load detection device for a vehicle seat, which comprises a magnetism generator equipped with a displaceable flexible element and a magnetic sensor, equipped with a fixing element of a flame, having a magnetic impedance element that detects a magnetic field generated by the magnetism generator. Since the magnetism generator includes a magnet having a specified size in this device, it is quite difficult to dispose the magnetism generator near a surface of a cushion material without any foreign object sensation. In order to avoid the foreign object sensation, it is considered that the magnetism generator is disposed inside the cushion material, but this leads to the deterioration of detection accuracy.

JP 2006-014756 A (Patent Document 4) discloses a biosignal detection device which comprises a permanent magnet and a magnetic sensor. Since the device also employs the permanent magnet which would give a foreign object sensation, it is difficult to place the device near a surface of the cushion material. The displacement of the device inside the cushion material leads to the deterioration of detection accuracy.

### SUMMARY OF THE INVENTION

The present inventors have already proposed a deformation detection sensor wherein a magnetic resin, in which magnetic filler is dispersed in a resin, is employed and is combined with a magnetic sensor, in order to enhance the durability of the deformation detection sensor and to obtain a seat which does not provide any foreign object sensation, but it is further desired to enhance the sensibility of the sensor and the stability of detection properties. As the results of the intense study, the present inventors have found that, by making the shape of the magnetic resin not to be simple layer structure but making the central portion of the magnetic resin to be thicker, the sensibility of the sensor and the stability of properties can be enhanced, thus the present invention having been accomplished.

Accordingly, the present invention provides a deformation detection sensor which comprises:

a magnetic resin-containing polymer foam which comprises a magnetic resin, in which a magnetic filler is contained, and a polymer foam in which the magnetic resin is included, and

a magnetic sensor that detects a magnetic change caused by a deformation of the magnetic resin-containing polymer foam,

wherein the magnetic resin has a convex portion on either a surface facing the magnetic sensor or a surface facing opposite to the magnetic sensor.

It is preferred that the convex portion of the magnetic resin is present in a central portion on either a surface facing the magnetic sensor or a surface facing opposite to the magnetic sensor, and the central portion of the magnetic resin has a thickness thicker than the peripheral portion thereof.

In addition, assuming that a short side of a cross section including the convex portion of the magnetic resin is L₁ and a long side is L₂, when the convex portion is present on the surface facing with the magnetic sensor, a relation of 0.5≦L₁/L₂<1 is satisfied and, when the convex portion of the magnetic resin is present on the surface opposing to the magnetic sensor, a relation of 0.3≦L₁/L₂≦0.9 is satisfied.

The cross section of the magnetic resin including the convex portion preferably has a trapezoid shape.

It is also preferred that the magnetic resin-containing polymer foam is a cushion pad for a vehicle and the deformation to be detected occurs by a sitting of a person.

The present invention also provides a method for producing a deformation detection sensor, comprising the steps of:

a step of dispersing a magnetic filler in a resin precursor solution,

a step of pouring the resin precursor solution into a container having a convex portion on one of surfaces,

a step of curing the resin precursor solution to form a magnetic resin having a convex portion on one of the surfaces,

a step of placing the magnetic resin in a mold for a polymer foam such that the surface of the magnetic resin, on which the convex portion is not present or not, faces an inner surface of the mold,

a step of pouring a raw material of the polymer foam into the mold to foam, whereby the magnetic resin is integrated with the polymer foam, and

a step of combining the magnetic resin-containing polymer foam with a magnetic sensor that detects a magnetic change caused by a deformation of the magnetic resin-containing polymer foam, such that the convex portion of the magnetic resin faces the magnetic sensor.

It is preferred that the placement of the magnetic resin is conducted by an attraction power of a magnet portion disposed in the mold for the polymer foam.

According to the present invention, since the thickness of the central portion of the magnetic resin is thickened, the magnetic flux density of the central portion is enhanced and the sensitivity of the deformation detection is also increased. In addition, since the thickness of the central portion of the magnetic resin is thickened and that of the peripheral portion is thinner, solution flowability is improved and air pockets are rarely formed, when raw material solution of polymer foam is poured into the mold in the preparation of the polymer foam, to result in high yield rate and high stability of physical properties.

According to one embodiment of the present invention, the convex portion of the magnetic resin is formed on the central portion of the magnetic resin and is made to reside within the surface of the polymer foam when molding the polymer foam. After forming the polymer foam, the convex portion is surrounded by the polymer foam, which exhibits anchor effects, thus resulting excellent stability of the physical properties after severe durability tests.

Since the magnetic filler is dispersed in the resin for the magnetic resin of the present invention, it can hardly provide foreign object sensation to persons sitting thereon and shows comfortable to sit in when it is used for a seat in a vehicle, in comparison with that using a solid magnetic. In addition, as the magnetic sensor detects a magnetic change caused by the magnetic filler contained in the magnetic resin, the magnetic sensor can be disposed separately with a certain distance apart from the magnetic resin and can be placed without wiring to connect with an electrode, which does not show any problems, such as cutting wire or poor durability. Further, since wiring to connect with an electrode is not necessary, it is not necessary to place any foreign object in the polymer foam and a production of the deformation detection sensor would become easily.

### BRIEF DESCRIPTION OF THE DRAWINGS

FIG. 1 is a schematic sectional view which shows an embodiment that the deformation detection sensor of the present invention is applied to a seat for a vehicle, wherein the convex portion of the magnetic resin is present on the surface which faces the magnetic sensor. The magnetic resin has a cross section of the convex portion with a step shape.

FIG. 2 shows a schematic perspective view of the magnetic resin-containing polymer foam of the present invention as is shown in FIG. 1.

FIG. 3 shows a schematic sectional view which shows an embodiment that the deformation detection sensor of the present invention is applied to a seat for a vehicle, wherein the convex portion of the magnetic resin is present on the surface which faces opposite to the magnetic sensor. The magnetic resin has a cross section of the convex portion with a step shape, similar to FIG. 1.

FIG. 4 shows a schematic perspective view of the magnetic resin-containing polymer foam of the present invention as is shown in FIG. 3.

FIG. 5 shows an enlarged perspective view of the magnetic resin 4 of FIGS. 1 to 4.

FIG. 6 shows a perspective view of a magnetic resin having a cross section of a trapezoid shape.

FIG. 7 shows a perspective view of a magnetic resin having a cross section of another shape.

FIG. 8 shows a perspective view of a magnetic resin having a cross section of an additional another shape.

FIG. 9 shows a perspective view of a magnetic resin having a cross section of a further another shape.

### DETAILED DESCRIPTION OF THE PREFERRED EMBODIMENTS

The present invention will be explained in detail by referring the drawings.

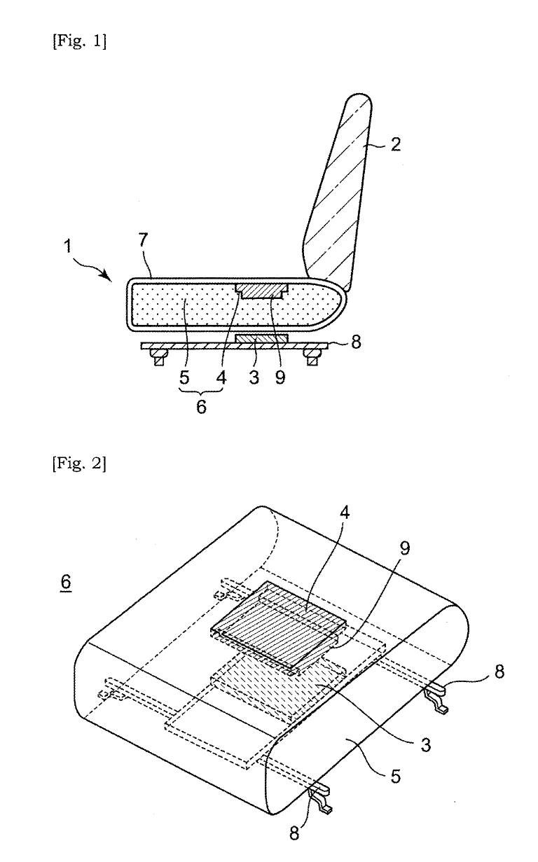

FIG. 1 is a schematic sectional view which shows an embodiment that the deformation detection sensor of the present invention is applied to a seat for a vehicle, wherein the convex portion of the magnetic resin is present on the surface which faces the magnetic sensor. The magnetic resin has a cross section of the convex portion with a step shape.

FIG. 2 shows a schematic perspective view of the magnetic resin-containing polymer foam of the present invention as is shown in FIG. 1.

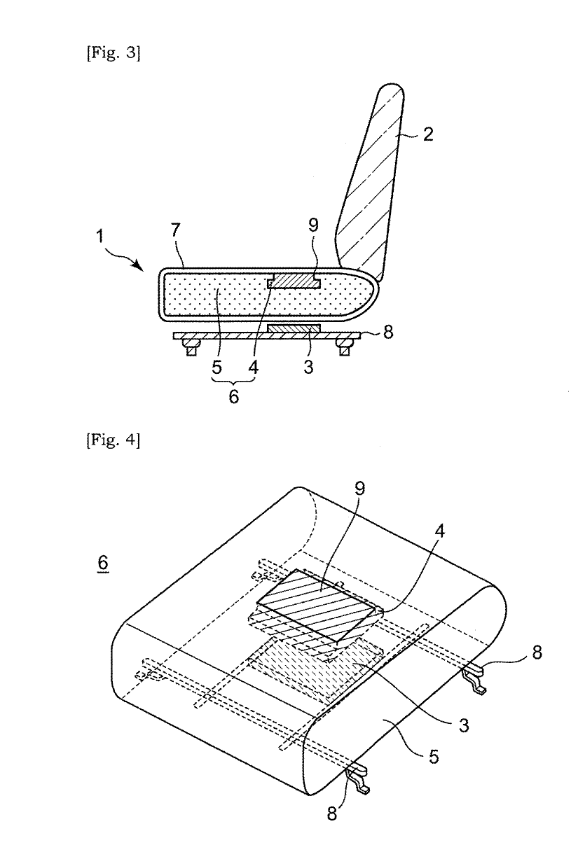

FIG. 3 shows a schematic sectional view which shows an embodiment that the deformation detection sensor of the present invention is applied to a seat for a vehicle, wherein the convex portion of the magnetic resin is present on the surface which faces opposite to the magnetic sensor. The magnetic resin has a cross section of the convex portion with a step shape, similar to FIG. 1.

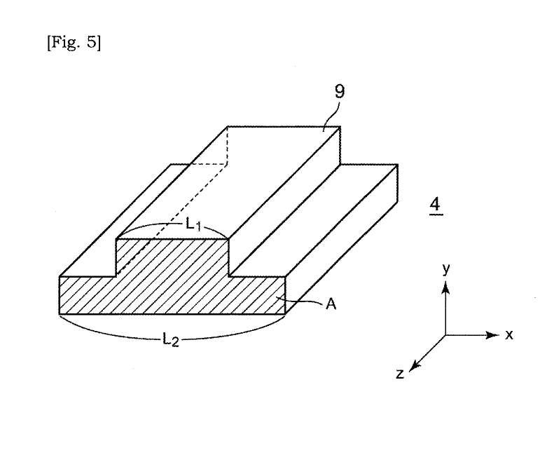

FIG. 4 shows a schematic perspective view of the magnetic resin-containing polymer foam of the present invention as is shown in FIG. 3.

As shown in FIGS. 1 and 3, the deformation detection sensor of the present invention is basically composed of a sitting portion 1 and a magnetic sensor 3. When the deformation detection sensor is used for a seat for a vehicle, a backrest portion 2 is present in contact with an end portion of the sitting portion 1. The sitting portion 1 is composed of a magnetic resin-containing polymer foam 6 which comprises a magnetic resin 4 and a polymer foam 5; and an outer skin 7 covering the magnetic resin-containing polymer foam 6. The magnetic resin 4 is disposed in layer in a portion of the sitting surface in the polymer foam 5. It is preferred that the magnetic sensor 3 is fixed to a pedestal 8 supporting the seat for a vehicle. The pedestal 8 is fixed to a car body in the case of a car, which is not shown in the figures. In FIG. 1, the magnetic resin 4 has a convex portion 9 with a cross section of a step shape in its central portion and the convex portion 9 extends to a direction perpendicular to the paper drawing FIG. 1. In addition, the convex portion 9 faces the magnetic sensor 3. In FIG. 3, the convex portion 9 is present in its central portion, but faces opposite to the magnetic sensor 3, which is opposite to FIG. 1 and constitutes an uppermost surface of the magnetic resin-containing polymer foam 6. It should be noted that, although FIGS. 1 and 3 show different embodiments from each other, same numbers are used in the drawings because only difference resides in the magnetic resin 4 being upside down.

FIGS. 2 and 4 shows a perspective view of the magnetic resin-containing polymer foam 6 of the present invention, which is composed of the magnetic resin 4 and the polymer foam 5, and it further shows the pedestal 8 and the magnetic sensor 3 mounting on the pedestal 8. The magnetic resin 4 is disposed on an uppermost portion of the polymer foam, which can highly receive the deformation when a person is sitting on the seat. FIG. 2 does not show the outer skin 7 which is present on the magnetic resin-containing polymer foam 6. The outer skin 7 is generally made of leather, fabric, synthetic resin or the like, which is not limited thereto. In FIG. 2, the convex portion 9 of the magnetic resin 4 faces the magnetic sensor 3, but in FIG. 4, the convex portion faces opposite to the magnetic sensor 3 and constitutes an uppermost surface of the magnetic resin-containing polymer foam 6.

The magnetic resin 4 contains a magnetic filler dispersed therein, which has magnetism by way of a magnetization method or another method. When a person sits on the sitting portion 1, the magnetic resin-containing polymer foam 6 is deformed and the magnetic field is changed thereby. The change of the magnetic field is detected by the magnetic sensor 3 to inspect the person sitting on the seat. In FIGS. 1 to 4, the polymer foam 6 which contains the magnetic resin 4 is present near a buttock of the person and, when the person is sitting, the sensor inspects it and, for example, when the person does not wear a seat belt, it alerts to the person. In addition, the magnetic resin-containing polymer foam 6 may be used as a backrest which contacts a backside of a person. When the polymer foam 6 is used as a backrest, the magnetic sensor can detect a posture of the sitting person.

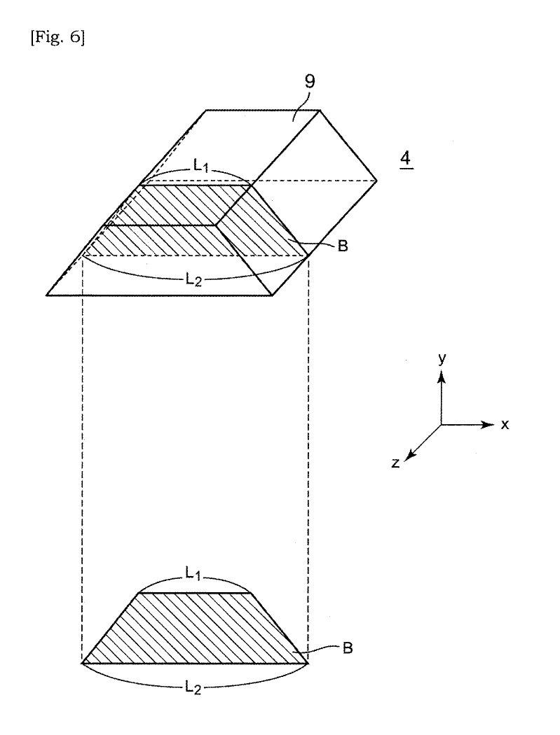

FIG. 5 shows an enlarged perspective view of the magnetic resin 4 of FIGS. 1 to 4. The convex portion 9 (looks like a protruded ridge in FIG. 5) extends to one direction of three directions perpendicular to each other (z axis in FIG. 3). A cross section A on a plane (x-y plane) crossing perpendicularly with the z axis is a step shape. The convex portion of magnetic resin 4 resides in a central portion of the magnetic resin 4 and it is thicker in its central portion than its peripheral portion. The larger thickness in the central portion than the peripheral portion of the magnetic resin 4 can be expressed as in FIG. 5 the short side L₁ in the cross section A is smaller than the long side L₂. In the embodiments of FIGS. 1 and 2, a ratio of L₁/L₂ can preferably meet the relation of 0.5≦L₁/L₂<1.0. If the ration of L₁/L₂ is less than 0.5, then the magnetic flux density tends to be low and if it is more than 1.0, the stability of the properties tends to be deteriorated. It is also preferred that L₂ is within the range of 1 to 100 mm and L₁ is within the range of 0.5 to 100 mm in view of the inequality. In the embodiment of FIGS. 3 and 4, a ratio of L₁/L₂ can preferably meet the relation of 0.3≦L₁/L₂≦0.9. If the ratio of L₁/L₂ is less than 0.3, then the magnetic flux density tends to be low and if it is more than 0.9, the stability of the properties tends to be deteriorated. It is also preferred that L₂ is within the range of 1 to 100 mm and L₁ is within the range of 0.3 to 90 mm in view of the inequality.

The magnetic resin 4 of FIGS. 1 to 4 is not always the protruded ridge with a step shape, as shown in FIG. 5 and can have any shape as long as it has a convex portion (or a thick portion) on a surface facing the magnetic sensor or facing opposite to the magnetic sensor. This makes magnetic flux density high and sensitivity enhanced. In addition, since the thickness of the central portion of the magnetic resin is thickened, the solution flowability is improved and air voids or air gaps are rarely formed, when raw material solution of polymer foam is poured into the mold in the preparation of the polymer foam. In the embodiments of FIGS. 3 and 4, the short side of the cross section of the convex portion is made upper portion and the long side of the cross section of the convex portion is made lower portion against the magnetic sensor. In this embodiment, the magnetic resin can be strongly fixed in the polymer foam by anchor effects and shows excellent stability of the properties after durability test. The shape of the magnetic resin 4 is not only such rectangular shape as shown in the drawings, but also can be circular shape or another shape.

It is preferred that the magnetic resin 4 has a thickness of 0.5 to 20 mm, preferably 1.0 to 5.0 mm. Thicknesses of less than 0.5 mm lower an amount of the magnetic filler and deteriorate the detection accuracy of the sensor and those of more than 20 mm have a tendency to provide a foreign object sensation given by the magnetic resin to the person sitting.

Some of examples of the magnetic resin 4 are shown in FIGS. 6 to 9, but are not limited thereto. The upper drawing in FIG. 6 shows that the convex portion 9 extends to one direction of three directions that are orthogonal with each other (z axis in FIG. 6) and has a cross section B of a trapezoid on an x-y plane which is orthogonal to the z axis. The lower drawing of FIG. 6 only shows the cross section B on the x-y plane. In the case where the cross section B is the trapezoid as shown in FIG. 6 and the convex portion of the magnetic resin faces the magnetic sensor, assuming that a short side is L₁ and a long side is L₂, it preferably meets a relation of 0.5≦L₁/L₂<1.0. When the convex portion of the magnetic resin faces opposite to the magnetic sensor, assuming that a short side is L₁ and a long side is L₂, it preferably meets a relation of 0.3≦L₁/L₂≦0.9. In either case, the thickness of the magnetic resin shows thicker in the central portion than that in the peripheral portion.

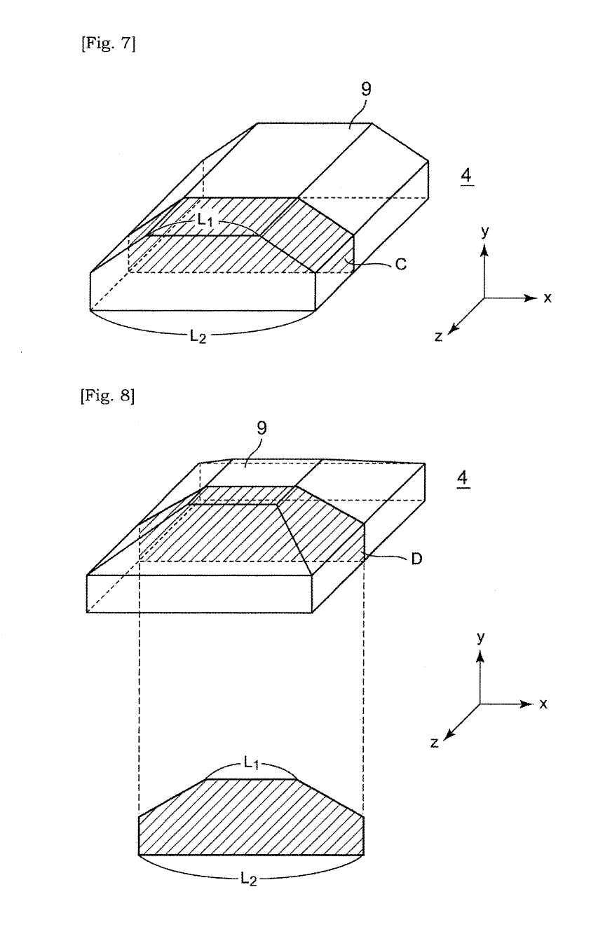

In FIG. 7, the convex portion 9 extends to one direction (z axis) of the three directions that are orthogonal with each other and has a cross section C of a rectangle, on which a trapezoid is placed, on an x-y plane which is orthogonal to the z axis. FIG. 8 shows a variation of the example of FIG. 7, having a mound around the central portion, like a truncated square pyramid. In FIG. 8, the cross section D on an x-y plane of the magnetic resin 4 shows a trapezoid on a rectangle, similar to FIG. 7. Although FIG. 8 does not show, a cross section on a y-z plane which is orthogonal to the z axis also has a trapezoid on a rectangle, as same with the cross section D. In the cases of FIGS. 7 and 8, the thickness of the magnetic resin shows thicker in the central portion than that in the peripheral portion.

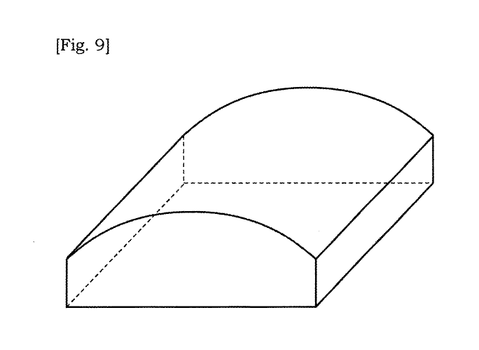

FIG. 9 shows a variation of FIG. 7 and an example with an arch in upper portion of the magnetic resin. As shown in FIG. 9, the magnetic resin can have a shape of a cuboid on which a cylinder cut in a longitudinal direction is placed, like a semicylindrical shape.

The magnetic resin 4 of the present invention may have a shape as shown in FIGS. 5 to 9 and may contain more magnetic fillers in its central portion, which makes magnetic flux density higher in the central portion. When the convex portion 9 of the magnetic resin 4 is placed facing the magnetic sensor 3 or facing opposite to the magnetic sensor 3, the higher magnetic flux density would increase detection sensitivity of deformations. In addition, as shown in FIGS. 3 and 4, in the case where the central convex portion (short side) of the magnetic resin is present facing opposite to the magnetic sensor, the magnetic resin exhibits anchor effects by the presence of surrounding longitudinal portions in the polymer foam and shows excellent property stability after durability tests. The convex portion 9 of the magnetic resin 4 extends to the direction perpendicular to the paper of FIG. 1 or FIG. 3, but it may extend to the direction paralleled to the paper of FIG. 1 or FIG. 3, even in which the magnetic filler contains more in the central portion and shows excellent sensitivity of detection of deformations.

Magnetic Resin

The term “magnetic resin” employed in the present specification means a resin in which a magnetic filler (an inorganic filler having magnetism) is dispersed.

The magnetic filler generally includes rare earth-based, iron-based, cobalt based, nickel-based or oxide-based filler, which can be used in the present invention. The rare earth-based magnetic filler is preferred because it shows high magnetism, but is not limited thereto. Neodymium-based magnetic filler is more preferred. A shape of the magnetic filler is not limited, but includes spherical, flake, needle, columnar or indefinite shape. The magnetic filler may preferably have an average particle size of 0.02 to 500 μm, preferably 0.1 to 400 μm, more preferably 0.5 to 300 μm. If it has an average particle size of less than 0.02 μm, the magnetic properties of the magnetic filler become poor and if it has an average particle size of more than 500 μm, the mechanical properties (e.g. brittleness) of the magnetic resin become poor.

The magnetic filler may be introduced into the resin after it is magnetized, but it is preferred that the magnetic filler is magnetized after it is introduced into the resin, because the polarity of the magnetic filler can be easily controlled and the detection of magnetism can be easily carried out.

The resin for the magnetic resin can be general resin, but preferably includes thermoplastic elastomer, thermosetting elastomer or a mixture thereof. Examples of the thermoplastic elastomers are styrene based thermoplastic elastomer, polyolefin based thermoplastic elastomer, polyurethane based thermoplastic elastomer, polyester based thermoplastic elastomer, polyamide based thermoplastic elastomer, polybutadiene based thermoplastic elastomer, polyisoprene based thermoplastic elastomer, fluororubber based thermoplastic elastomer and the like. Examples of the thermosetting elastomer are diene based synthetic rubber, such as polyisoprene rubber, polybutadiene rubber, styrene-butadiene rubber, polychloroprene rubber, nitrile rubber, and ethylene-propylene rubber; non-diene based synthetic rubber, such as ethylene-propylene rubber, butyl rubber, acryl rubber, polyurethane rubber, fluororubber, silicone rubber, and epichlorohydrin rubber; natural rubber; and the like. Among them, thermosetting elastomer is preferred, because it can be used in a long period of time during which damage or fatigue of the magnetic resin can be inhibited. More preferred is polyurethane elastomer (also mentioned herein as polyurethane rubber) or silicone elastomer (also mentioned herein as silicone rubber).

The resin can preferably be polyurethane elastomer or silicone elastomer. In the case of polyurethane elastomer, an active hydrogen-containing compound is mixed with a magnetic filler, into which an isocyanate component is added and mixed to form a mixture solution. In addition, polyurethane elastomer can also be prepared by mixing an isocyanate component with a magnetic filler, into which an active hydrogen-containing compound is added and mixed to form a mixture solution. The resulting mixture solution is poured in a mold which has been treated with a releasing agent, and then heated to a curing temperature to cure, thus obtaining a polyurethane elastomer. In the case of silicone elastomer, a precursor of silicone elastomer is combined with a magnetic filler and mixed, followed by heating it to cure, thus obtaining a silicone elastomer. When forming the mixture solution, a solvent may be added thereto, if necessary.

The isocyanate component and the active hydrogen-containing component to be employed for the polyurethane elastomer are listed hereinafter.

The isocyanate component is not limited and can be anyone that has been employed in the field of polyurethane. Examples of the isocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate; an aliphatic diisocyanate, such as ethylene diisocyanate, 2,2,4-trimethylhexamethylene diisocyanate, and 1,6-hexamethylene diisocyanate; an alicyclic diisocyanate, such as 1,4-cyclohexane diisocyanate, 4,4′-dicyclohexylmethane diisocyanate, isophorone diisocyanate, and norbornane diisocyanate. The compounds can be used alone or in combination of two or more compounds thereof. In addition, the isocyanate can be modified by urethane modification, allophanate modification, biuret modification, isocyanulate modification or the like.

The active hydrogen-containing compound can be anyone that has been employed in the field of polyurethane. Examples of the active hydrogen-containing compounds are a polyether polyol, such as polytetramethylene glycol, polypropylene glycol, polyethylene glycol and a copolymer of polypropylene oxide and polyethylene oxide; a polyester polyol, such as polybutylene adipate, polyethylene adipate, and 3-methyl-1,5-pentane adipate; a polyester polycarbonate polyol, such as a reaction product of a polyester glycol (e.g. polycaprolactone polyol and polycaprolactone) and an alkylene carbonate; a polyester polycarbonate polyol obtained by reacting ethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof.

In addition to the above-mentioned high molecular weight polyol component, the active hydrogen-containing component can also include a low molecular weight polyol, such as ethylene glycol, 1,2-propylene glycol, 1,3-propylene glycol, 1,4-butanediol, 1,6-hexanediol, neopentyl glycol, 1,4-cyclohexane dimethanol, 3-methyl-1,5-pentanediol, diethylene glycol, triethylene glycol, 1,4-bis(2-hydroxyethoxy)benzene, trimethylolpropane, glycerin, 1,2,6-hexane triol, pentaerythritol, tetramethylol cyclohexane, methyl glucoside, sorbitol, mannitol, dulcitol, sucrose, 2,2,6,6-tetrakis(hydroxymethyl)cyclohexanol, and triethanolamine; and a low molecular weight polyamine, such as ethylenediamine, tolylenediamine, diphenylmethanediamine, diethylenetriamine and the like. These compounds can be used alone or a combination of two or more compounds thereof. A polyamine, including 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-dimethyltoluene-2,4-diamine, 3,5-diethyltoluene-2,6-diamine, triethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′, 5,5′-tetraethyldiphenylmethane, m-xylylenediamine, N,N′-di-sec-butyl-p-phenylenediamine, m-phenylenediamine, p-xylylenediamine; and the like, may also be added thereto.

An amount of the magnetic filler in the magnetic resin can preferably be 1 to 450 parts by weight, more preferably 2 to 400 parts by weight, based on 100 parts by weigh of the resin. Amounts of less than 1 part by weight make it difficult to detect magnetic changes and those of more than 450 parts by weight make the resin brittle and do not obtain the desired properties.

The magnetic resin may be non-foamed and does not have any foamed cell, but the magnetic resin may be foamed and has foamed cells, in view of stability, enhanced detection accuracy of the magnetic sensor 3 and weight reduction. A foamed body can be a foamed resin, but a thermosetting resin foam is preferred because of physical properties, such as compression set and the like. The thermosetting resin foam can be polyurethane resin foam, silicone resin foam and the like, but polyurethane resin foam is more preferred. The polyurethane resin foam can be obtained from the isocyanate component and active hydrogen-containing compound as mentioned above.

In the present invention, a peripheral portion of the magnetic resin may be sealed by a sealing material as far as it does not deteriorate the flexibility of the magnetic resin. The sealing material can be thermoplastic resin, thermosetting resin or a mixture thereof. The thermoplastic resin includes styrene based thermoplastic elastomer, polyolefin based thermoplastic elastomer, polyurethane based thermoplastic elastomer, polyester based thermoplastic elastomer, polyamide based thermoplastic elastomer, polybutadiene based thermoplastic elastomer, polyisoprene based thermoplastic elastomer, fluoride based thermoplastic elastomer, ethylene ethylacrylate copolymer, ethylene vinylacetate copolymer, polyvinylchloride, polyvinylidene chloride, chlorinated polyethylene, fluoride resin, polyamide, polyethylene, polypropylene, polyethylene terephthalate, polybutylene terephthalate, polystyrene, polybutadiene or the like. The thermosetting resin includes, for example, diene based synthetic rubber, such as polyisoprene rubber, polybutadine rubber, styrene-butadiene rubber, polychloroprene rubber and acrylonitrile butadiene rubber; non-diene based rubber, such as ethylene-propylene rubber, ethylene-propylene-diene rubber, butyl rubber, acryl rubber, polyurethane rubber, fluororubber, silicone rubber and epichlorohydrine rubber; natural rubber; polyurethane resin; silicone resin; epoxy resin; or the like. When the sealing material is thermoplastic resin, thermosetting resin or a mixture thereof, it can be used in the form of film. The film can be a laminated film, a metal foil (e.g. aluminum foil) or a film having vapor deposited film composed of a film on which a metal is vapor deposited. The sealing material has technical effects that inhibit the formation of rust of the magnetic filler in the magnetic resin.

Process for Producing the Deformation Detection Sensor

The present invention also provides a method for producing a deformation detection sensor, comprising the steps of:

a step of dispersing a magnetic filler in a resin precursor solution,

a step of pouring the resin precursor solution into a container having a convex portion on one of surfaces,

a step of curing the resin precursor solution to form a magnetic resin having a convex portion on one of the surfaces,

a step of placing the magnetic resin in a mold for a polymer foam such that the surface of the magnetic resin, on which the convex portion is not present, faces an inner surface of the mold,

a step of pouring a raw material of the polymer foam into the mold to foam, whereby the magnetic resin is integrated with the polymer foam, and

a step of combining the magnetic resin-containing polymer foam with a magnetic sensor that detects a magnetic change caused by a deformation of the magnetic resin-containing polymer foam, such that the convex portion of the magnetic resin faces the magnetic sensor.

The magnetic resin can be produced by formulating the magnetic filler in the resin precursor solution, when preparing the resin, and reacting it in a container. The container may be a specific one which forms a magnetic resin having a convex portion on one surface. The magnetic resin is placed in a mold for the polymer foam, such that the surface without the convex portion faces inside of the mold, into which a raw material for the polymer foam is poured. The raw material is foamed to obtain the magnetic resin-containing polymer foam in which the magnetic resin is integrated with the polymer foam.

When the magnetic resin is placed in the mold for the polymer foam, the placement of the magnetic resin is easily conducted by using magnetism attracting a magnetized material, for example a magnet is preliminary put in the mold and attracts the magnetic resin. The magnet may be preliminary placed in a place where the magnetic resin is disposed, or the placement may be carried out by operating the strong magnetic outside the mold to a place where the magnetic resin is disposed. The placement of the magnetic resin may also be conducted by using a double side adhesive tape or an adhesive agent to adhere the magnetic resin therewith, in addition to the use of the magnet.

Polymer Foam

The polymer foam can be obtained by foaming a raw solution of the polymer foam, as mentioned above. The polymer foam can be a general resin foam and among them thermosetting resin foam, such as polyurethane resin foam or silicone resin foam, is preferred. In the case of polyurethane resin foam, the raw solution generally comprises a polyisocyanate component, a polyol and an active hydrogen-containing compound such as water. The polyisocyanate component and active hydrogen-containing compound are listed hereinafter.

The polyisocyanate component can be anyone that has been used in the field of polyurethane. Examples of the polyisocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, m-xylylene diisocyanate and the like. It can also be polynuclear compounds of diphenylmethane diisocyanate (crude MDI). The polyisocyanate compound can further be an aliphatic diisocyanate, such as ethylene diisocyanate, 2,2,4-trimethylhexamethylene diisocyanate and 1,6-hexamethylene diisocyanate; an alicyclic diisocyanate, such as 1,4-cyclohexane diisocyanate, 4,4′-dicyclohexylmethane diisocyanate, isophorone diisocyanate, norbornane diisocyanate; and the like. These can be used alone or in combination with two or more isocyanates thereof. In addition, the isocyanate can be modified by urethane modification, allophanate modification, biuret modification, isocyanulate modification or the like.

The active hydrogen-containing compound can be anyone that has generally been used in the field of polyurethane. Examples of the active hydrogen-containing compounds are a polyether polyol, such as polytetramethylene ether glycol, polypropylene glycol, polyethylene glycol and a copolymer of propylene oxide and ethylene oxide; a polyester polyol, such as polybutylene adipate, polyethylene adipate, and 3-methyl-1,5-pentane adipate; a polyester polycarbonate polyol, such as a reaction product of polyester glycol (e.g. polycaprolactone polyol or polycaprolactone) and alkylene carbonate; a polyester polycarbonate polyol obtained by reacting polyethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof. The concrete examples of the active hydrogen-containing compounds include, for example EP 3028, EP 3033, EP 828, POP 3128, POP 3428 and POP 3628, commercially available from Mitsui Chemical Inc.; and the like.

When producing the polymer foam, other components, such as crosslinking agent, foam stabilizer, catalyst and the like can be employed and they are not limited thereto.

The crosslinking agent may include triethanolamine, diethanolamine or the like. The foam stabilizer may include SF-2962, SRX-274C, 2969T and the like, available from Dow Corning Toray Co., Ltd. Examples of the catalysts are Dabco 33LV available from Air Products Japan Co., Ltd., Toyocat ET, SPF2, MR available from Tosoh Corporation, and like.

In addition, an additive, such as water, toner, flame retardant or the like can be suitably employed if necessary.

Examples of the flame retardants are CR 530 or CR 505 available from Daihachi Chemical Industry Co., Ltd.

Deformation Detection Sensor

The magnetic resin-containing polymer foam as obtained above can be combined with the magnetic sensor, such that the convex portion of the magnetic resin faces the magnetic sensor or faces opposite to the magnetic sensor, to obtain the deformation detection sensor. In the deformation detection sensor, the magnetic resin-containing polymer foam contains the magnetic resin such that the convex portion of the magnetic resin faces the magnetic sensor or faces opposite to the magnetic sensor and is deformed by a person sitting on the seat to change magnetism. The magnetic change is detected by the magnetic sensor to find the person sitting on the seat. In the present invention, the convex portion of the magnetic resin faces the magnetic sensor or faces opposite to the magnetic sensor, so that the portion containing more amounts of filler (i.e. the convex portion) in the magnetic resin is changed to easily detect the change of magnetism. In addition, as shown in FIG. 3, when the convex portion of the magnetic resin is disposed such that the convex portion comes to a surface of the polymer foam, the portion other than the convex portion is present inside of the polymer foam and exhibits anchor effects thereby, thus resulting in excellent stability of properties after durability tests.

According to the production method of the deformation detection sensor of the present invention, the magnetic resin can be either upper surface or lower surface of the polymer foam, as long as the convex portion of the magnetic resin faces the magnetic sensor or faces opposite to the magnetic sensor. The magnetic resin can also be present inside of the polymer foam, as long as the convex portion of the magnetic resin faces the magnetic sensor or faces opposite to the magnetic sensor.

The magnetic sensor can be anyone that has generally been used for detecting magnetism. It may include a magnetoresistive element (e.g. a semiconductor magnetoresistive element, an anisotropic magnetoresistive element (AMR), a gigantic magnetoresistive element (GMR) or a tunnel magnetoresistive element (TMR)), a hall element, an inductor, an MI element, a flux gate sensor and the like. The hall element is preferred because it has excellent sensitivity widely or extensively.

In addition, the deformation detection sensor of the present invention can be used for different applications other than cushion pads for vehicles, such as a hand or a skin of a robot, a surface pressure distribution of a bed or the like, a road surface condition or an air pressure of a tire, an exercise condition of a living body (such as motion captures, respiratory conditions, relaxed states of muscle, and the like), an invasion into a keep-out area, a foreign object of a slide door.

### EXAMPLES

The present invention is further explained based on the following examples which, however, are not construed as limiting the present invention to their details.

### Example 1

Preparation of Magnetic Resin

A reaction vessel was charged with 85.2 parts by weight of polyol A (a polyoxypropylene glycol obtained by adding propylene oxide to glycerin initiator, OH value 56, Functionality 3; Excenol 3030 available from Asahi Glass Co., Ltd.) and was dehydrated at a reduced pressure with mixing for one hour. The reaction vessel was then changed to nitrogen atmosphere. Next, 14.8 parts by weight of toluene diisocyanate (2,4 configuration=100%, NCO %=48.3%; available from Mitsui Chemicals Inc.) was added to the reaction vessel and reacted for 3 hours at a temperature of 80° C. in the reaction vessel to synthesize a prepolymer A having a terminal isocyanate group (NCO %=3.58%). Separately, a mixture of 189.4 parts by weight of polyol A and 0.35 parts by weight of bismuth octylate (PUCAT 25 available from Nihon Kagaku Sangyo Co., Ltd.) was mixed with 675.3 parts by weight of neodymium based filler (NdFeB magnetic powder; available from Molycorp Magnequench Co., Ltd. as MQP-14-12; average particle size 50 μm) to obtain a filler dispersion. The filler dispersion was mixed with the prepolymer solution A mentioned above and mixed using a planetary centrifugal mixer (available from Thinky Corporation) and defoamed. The reaction solution was added dropwise to a container having a cross section of a trapezoid shape as FIG. 6, with a short side 15 mm and a long side 20 mm and adjusted to a 2.0 mm thickness with a doctor blade. It was then kept at 80° C. for 1 hour to cure to obtain a magnet filler dispersion resin. It was then magnetized at 2.0 T using a magnetizing apparatus (available from Tamakawa Co., Ltd.) to obtain a magnetic resin having a trapezoid cross section. The trapezoid cross section had a short side (L₁) of 15 mm, a long side (L₂) of 20 mm and a height of 2.0 mm.

Preparation of Magnetic Resin-Containing Polymer Foam

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The magnetic resin obtained above having a shape of FIG. 6 was cut to a length of 20 mm and was placed in a mold having of 400 mm square and a thickness of 70 mm at a desired position where a magnet had been disposed, and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a magnetic resin-containing polymer foam. The polymer foam was subjected to a determination of a change of average magnetic flux density (Gauss) and property stability (%) as explained hereinafter. The results are shown in Table 1. Table 1 also includes formulations of magnetic resins, NCO index and production conditions (shape of magnetic resin using figure number, short side length, long side length and a ratio of short side/long side).

Average Magnetic Flux Density Change

A hall element (available from Asahi Kasei Microdevices Corporation as EQ-430L) was adhered to an acryl board and was then attached to a surface of the polymer foam opposite to the side of the magnetic resin in the obtained magnetic resin-containing polymer foam. At this point, the convex portion of the magnetic resin faced the hall element. A pressure indenter having 10 mmφ was applied to a center portion of the magnetic resin at a pressure of 10 kPa to obtain a change (Gauss) of magnetic flux density by an output voltage change of the hall element. The measurement of the change of the magnetic flux density was conducted 10 times and its average was calculated therefrom. It was conducted at a temperature of 20° C.

Property Stability

A distribution of the change of magnetic flux density was determined by the following equation. The results are shown as property stability (%) in Table 1.

$$Property stability ( \% ) = \frac{\sqrt{\begin{matrix}( Measured magnetic flux density change - \\ {Average magnetic flux density change )}^{2}\end{matrix}}}{Average magnetic flux density change} \times 100$$

### Examples 2 to 5 and Comparative Example 1

A magnetic resin was prepared as generally described in Example 1, using the conditions of Table 1, with the exception that the container had its cross section of the short side and the long side shown in Table 1 instead of the container used for preparing the magnetic resin having its cross section of the short side L₁ 15 mm and the long side L₂ 20 mm used in Example 1. In Example 4, the cross section of the magnetic resin had a step like shape as shown in FIG. 5 and its short side and long side are shown in Table 1. In Comparative Example 1, the short side and the long side were same with 20 mm. A magnetic resin-containing polymer foam was prepared as generally described in Example 1 and its average magnetic flux density change (Gauss) and property stability (%) were measured as described above. Its results are shown in Table 1. Table 1 also shows a ratio of short side (L₁)/long side (L₂). The column of magnetic resin shape indicates number of drawing.

TABLE 1

| | | | | | | | | Comparative |
|---|---|---|---|---|---|---|---|---|
| | | | Examples | | | | | Example |
| | | | 1 | 2 | 3 | 4 | 5 | 1 |
| Formulation | Prepolymer | Prepolymer A | 100.0 | 100.0 | 100.0 | 100.0 | 100.0 | 100.0 |
| | Curing agent | Polyol A | 189.4 | 189.4 | 189.4 | 189.4 | 189.4 | 189.4 |
| | Filler | Neodymium Based (MQP-14-12) | 675.3 | 675.3 | 675.3 | 675.3 | 675.3 | 675.3 |
| | Catalyst | Bismuth octylate | 0.35 | 0.35 | 0.35 | 0.35 | 0.35 | 0.35 |

| | | | | | | | |
|---|---|---|---|---|---|---|---|
| | NCO index | 0.45 | 0.45 | 0.45 | 0.45 | 0.45 | 0.45 |
| Production | Shape of magnetic resin | FIG. 6 | FIG. 6 | FIG. 6 | FIG. 5 | FIG. 6 | — |
| conditions | Length of short side (L₁) (mm) | 15 | 12 | 18 | 16 | 6 | 20 |
| | Length of long side (L₂) (mm) | 20 | 20 | 20 | 20 | 20 | 20 |
| | Ratio of Short side (L₁)/Long side (L₂) | 0.75 | 0.60 | 0.90 | 0.80 | 0.30 | 1.00 |
| Results | Average magnetic flux density change (Gauss) | 2.7 | 2.2 | 3.7 | 3.0 | 1.2 | 2.3 |
| | Property stability (%) | 4.5 | 3.1 | 5.3 | 5.2 | 3.0 | 7.8 |

As is apparent from Table 1, the examples of the present invention are excellent in magnetic flux density change (Gauss) and property stability. Example 2 shows a lower L₁/L₂ ratio than Example 1 (steeper inclination). The amount of magnetic filler would be reduced slightly and the average magnetic flux density is lowered a little, but it is still usable level. Example 3 showed a larger L₁/L₂ ratio than Example 1 (moderate inclination). Property stability is slightly lowered because of easy occurrence of air voids, but it is still usable level. Example 4 shows an example of the magnetic resin having a cross section of a step shape instead of the trapezoid shape of Example. Property stability is slightly lowered because of easy occurrence of air voids at bend portions of the step, but it is still usable level. Example 5 shows a lower L₁/L₂ ratio than Example 1 (steeper inclination). The amount of magnetic filler would be reduced slightly and the average magnetic flux density is lowered a little, but it is still usable level. Comparative Example 1 easily develops air voids and deteriorates property stability, which is not usable for a deformation detection sensor.

### Example 6

Preparation of Magnetic Resin

A reaction vessel was charged with 85.2 parts by weight of polyol A (a polyoxypropylene glycol obtained by adding propylene oxide to glycerin initiator, OH value 56, Functionality 3; Excenol 3030 available from Asahi Glass Co., Ltd.) and was dehydrated at a reduced pressure with mixing for one hour. The reaction vessel was then changed to nitrogen atmosphere. Next, 14.8 parts by weight of toluene diisocyanate (2,4 configuration=100%, NCO %=48.3%; available from Mitsui Chemicals Inc.) was added to the reaction vessel and reacted for 3 hours at a temperature of 80° C. in the reaction vessel to synthesize a prepolymer A having a terminal isocyanate group (NCO %=3.58%).

Separately, a mixture of 189.4 parts by weight of polyol A and 0.35 parts by weight of bismuth octylate (PUCAT 25 available from Nihon Kagaku Sangyo Co., Ltd.) was mixed with 675.3 parts by weight of neodymium based filler (NdFeB magnetic powder; available from Molycorp Magnequench Co., Ltd. as MQP-14-12; average particle size 50 μm) to obtain a filler dispersion. The filler dispersion was mixed with the prepolymer solution A mentioned above and mixed using a planetary centrifugal mixer (available from Thinky Corporation) and defoamed. The reaction solution was added dropwise to a container having a cross section of a trapezoid shape as FIG. 5, with a short side 24 mm and a long side 40 mm and adjusted to a 2.0 mm thickness with a doctor blade. It was then kept at 80° C. for 1 hour to cure, thus obtaining a magnet filler dispersion resin. The resulting resin was then magnetized at 2.0 T using a magnetizing apparatus (available from Tamakawa Co., Ltd.) to obtain a magnetic resin having a trapezoid cross section. The step-like cross section had a short side (L₁) of 24 mm, a long side (L₂) of 40 mm and a height of 2.0 mm.

Preparation of Magnetic Resin-Containing Polymer Foam

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The magnetic resin obtained above having a shape of FIG. 5 was cut to a length of 40 mm and was placed in a mold having of 400 mm and a thickness of 70 mm at a desired position where a magnet had been disposed, such that the short side was contacted with the magnet, and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a magnetic resin-containing polymer foam. The polymer foam was subjected to a determination of a change of average magnetic flux density (Gauss) and property stability (%) as explained hereinafter. The results are shown in Table 1. Table 1 also includes a formulation of the magnetic resin, NCO index and production conditions (shape of magnetic resin using figure number, short side length, long side length and a ratio of short side/long side).

Average Magnetic Flux Density Change after Durability Test

A pressure indenter having 10 mmφ was applied to a center portion of the magnetic resin of the magnetic resin-containing polymer foam at a pressure of 50 kPa and durability tests were conducted 500,000 times. A hall element (available from Asahi Kasei Microdevices Corporation as EQ-430L) was adhered to an acryl board and was then attached to a surface of the polymer foam opposite to the side of the magnetic resin in the obtained magnetic resin-containing polymer foam. At this point, the convex portion of the magnetic resin faced opposite to the hall element. A pressure indenter having 10 mmφ was applied to a center portion of the magnetic resin at a pressure of 10 kPa to obtain a change (Gauss) of magnetic flux density by an output voltage change of the hall element. The measurement of the change of the magnetic flux density was conducted 10 times and its average was calculated therefrom. It was conducted at a temperature of 20° C.

Property Stability after Durability Test

A distribution of the change of magnetic flux density was determined by the following equation. The results are shown as property stability (%) in Table 2.

$$Property stability ( \% ) = \frac{\sqrt{\begin{matrix}( Measured magnetic flux density change - \\ {Average magnetic flux density change )}^{2}\end{matrix}}}{Average magnetic flux density change} \times 100$$

### Examples 7 to 10 and Comparative Example 2

A magnetic resin was prepared as generally described in Example 6, using the conditions of Table 2, with the exception that the container had its cross section of the short side and the long side shown in Table 2 instead of the container used for preparing the magnetic resin having its cross section of the short side L₁ 24 mm and the long side L₂ 40 mm used in Example 6. In Examples 9 and 10, the cross section of the magnetic resin had a trapezoid shape as shown in FIG. 6 and its short side and long side are shown in Table 2. In Comparative Example 2, the short side and the long side were same with 40 mm. A magnetic resin-containing polymer foam was prepared as generally described in Example 6 and its average magnetic flux density change (Gauss) and property stability (%) were measured as described above. Its results are shown in Table 2. Table 2 also shows a ratio of short side (L₁)/long side (L₂). The column of magnetic resin shape indicates number of figure.

TABLE 2

| | | | | | | | | Comparative |
|---|---|---|---|---|---|---|---|---|
| | | | Examples | | | | | Example |
| | | | 6 | 7 | 8 | 9 | 10 | 2 |
| Formulation | Prepolymer | Prepolymer A | 100.0 | 100.0 | 100.0 | 100.0 | 100.0 | 100.0 |
| | Curing agent | Polyol A | 189.4 | 189.4 | 189.4 | 189.4 | 189.4 | 189.4 |
| | Filler | Neodymium Based (MQP-14-12) | 675.3 | 675.3 | 675.3 | 675.3 | 675.3 | 675.3 |
| | Catalyst | Bismuth octylate | 0.35 | 0.35 | 0.35 | 0.35 | 0.35 | 0.35 |

| | | | | | | | |
|---|---|---|---|---|---|---|---|
| | NCO index | 0.45 | 0.45 | 0.45 | 0.45 | 0.45 | 0.45 |
| Production | Shape of magnetic resin | FIG. 5 | FIG. 5 | FIG. 6 | FIG. 6 | — | — |
| conditions | Length of short side (L₁) (mm) | 24 | 32 | 14 | 24 | 38 | 40 |
| | Length of long side (L₂) (mm) | 40 | 40 | 40 | 40 | 40 | 40 |
| | Ratio of short side (L₁)/Long side (L₂) | 0.60 | 0.80 | 0.35 | 0.60 | 0.95 | 1.00 |
| Results | Average magnetic flux density change after | 5.1 | 6.2 | 2.1 | 4.7 | 4.4 | 4.1 |
| | durability test (Gauss) | | | | | | |
| | Property stability after durability test (%) | 6.4 | 8.1 | 5.1 | 7.6 | 9.3 | 10.6 |

As is apparent from Table 2, the examples of the present invention are excellent in magnetic flux density change (Gauss) after durability test and property stability. Example 7 shows a larger L₁/L₂ ratio than Example 6 (moderate inclination). The property stability is slightly lowered because of anchor effects being reduced, but it is still usable level. Example 8 shows a smaller L₁/L₂ ratio than Example 6 (steeper inclination). The amount of magnetic filler would be reduced slightly and the average magnetic flux density is lowered a little, but it is still usable level. Example 9 shows an example of the magnetic resin having a cross section of a trapezoid shape instead of the step-like shape of Example 6. The property stability is slightly lowered because of anchor effects being reduced in comparison with Example 6, but it is still usable level. Example 10 shows a larger L₁/L₂ ratio than Example 6 (moderate inclination). The property stability is slightly lowered because of anchor effects being reduced, but it is still usable level. Comparative Example 2 does not have anchor effects and deteriorates property stability, which is not usable for a deformation detection sensor.

### INDUSTRIAL APPLICABILITY

The deformation detection sensor of the present invention can be applied to a seat for vehicles and is excellent in durability so that it endures a long period of use. In addition, the deformation detection sensor of the present invention has large magnetic density change and therefore shows good measuring sensitivity. The deformation detection sensor of the present invention does not develop air voids when producing and therefore shows excellent property stability.

### REFERENCE SIGNS LIST

1 Sitting portion
2 Backrest portion
3 Magnetic sensor
4 Magnetic resin
5 Polymer foam
6 Magnetic resin-containing polymer foam
7 Outer skin
8 Pedestal
9 Convex portion

1. A deformation detection sensor which comprises:
a magnetic resin-containing polymer foam which comprises a magnetic resin, in which a magnetic filler is contained, and a polymer foam in which the magnetic resin is included, and
a magnetic sensor that detects a magnetic change caused by a deformation of the magnetic resin-containing polymer foam,
wherein the magnetic resin has a convex portion on either a surface facing the magnetic sensor or a surface facing opposite to the magnetic sensor.

2. The deformation detection sensor according to claim 1, wherein the convex portion of the magnetic resin is present in a central portion on either a surface facing the magnetic sensor or a surface facing opposite to the magnetic sensor, and the central portion of the magnetic resin has a thickness thicker than the peripheral portion thereof.

3. The deformation detection sensor according to claim 1, wherein, assuming that a short side of a cross section including the convex portion of the magnetic resin is L₁ and a long side is L₂, when the convex portion is present on the surface facing the magnetic sensor, a relation of 0.5≦L₁/L₂<1 is satisfied and, when the convex portion of the magnetic resin is present on the surface facing opposite to the magnetic sensor, a relation of 0.3≦L₁/L₂≦0.9 is satisfied.

4. The deformation detection sensor according to claim 1, wherein the cross section of the magnetic resin including the convex portion has a trapezoid shape.

5. The deformation detection sensor according to claim 1, wherein the magnetic resin-containing polymer foam is a cushion pad for a vehicle and the deformation to be detected occurs by a sitting of a person.

6. A method for producing a deformation detection sensor, comprising the steps of:
a step of dispersing a magnetic filler in a resin precursor solution,
a step of pouring the resin precursor solution into a container having a convex portion on one of surfaces,
a step of curing the resin precursor solution to form a magnetic resin having a convex portion on one of the surfaces,
a step of placing the magnetic resin in a mold for a polymer foam such that the surface of the magnetic resin, on which the convex portion is present or not, faces an inner surface of the mold,
a step of pouring a raw material of the polymer foam into the mold to foam, whereby the magnetic resin is integrated with the polymer foam, and
a step of combining the magnetic resin-containing polymer foam with a magnetic sensor that detects a magnetic change caused by a deformation of the magnetic resin-containing polymer foam, such that the convex portion of the magnetic resin faces the magnetic sensor.

7. The method of producing the deformation detection sensor according to claim 6, wherein the placement of the magnetic resin is conducted by an attraction power of a magnet portion disposed in the mold for the polymer foam.
